(19) United States
(12) Patent Application Publication
(10) Pub. No.: US 2025/0139151 A1
(43) Pub. Date: May 1, 2025

(54) DATA STRUCTURE MODIFICATION USING A VIRTUAL ASSISTANT BASED ON LARGE LANGUAGE MODELS AND ONTOLOGY

(71) Applicant: ADP, Inc., Roseland, NJ (US)

(72) Inventors: Leandro Da Silva Bianchini, Parsippany, NJ (US); Dalmir Antonio Da Silva, Aurora, CO (US); Eduardo Lutz, Porto Alegre (BR); Ricardo Piccoli, Porto Alegre (BR)

(73) Assignee: ADP, Inc., Roseland, NJ (US)

(21) Appl. No.: 18/927,299

(22) Filed: Oct. 25, 2024

Related U.S. Application Data
(60) Provisional application No. 63/593,869, filed on Oct. 27, 2023.

(51) Int. Cl. G06F 16/36; G06F 16/332

(52) U.S. Cl. CPC G06F 16/367; G06F 16/3329

(57) ABSTRACT

A system can receive, via a chatbot interface, a textual input related to an electronic report. The system can generate, using a large language model, an output including a set of keywords, a rephrased version of the textual input, and an intent sentence. The system can filter, using the output from the large language model, an ontology stored in a database to generate a filtered ontology, including one or more ontology elements, intents, and examples. The system can generate, using the large language model and the filtered ontology, a plurality of actions that are compatible with the electronic report. The system can display, via the chatbot interface, the actions. The system can receive, via the chatbot interface, an indication to execute an action. The system can provide, responsive to the indication, instructions to execute the action on the electronic report to modify the electronic report.

### CROSS-REFERENCE TO RELATED APPLICATIONS

This application claims the benefit of priority to U.S. Provisional Application No. 63/593,869, filed Oct. 27, 2023, the entirety of which is incorporated by reference herein.

### TECHNICAL FIELD

This application is generally related to natural language processing, and, more particularly, to data structure modification using a virtual assistant based on large language models and ontology.

### BACKGROUND

Natural language processing can be used for efficient information storage, retrieval, and analysis across various fields. Natural language processing systems can process user prompts and provide contextually relevant responses. Natural language processing operations can be executed to improve query resolution and information management.

### SUMMARY

Aspects of technical solutions described herein can be directed to a computing architecture configured for managing operations across natural language processing, data management, and system scalability in virtual assistant systems. In this regard, challenges can arise in processing prompts and understanding user intent within a specific domain due to factors such as ambiguity, context, and variations in language. Additionally, efficiently managing and accessing data from various sources, including ontologies and databases, can be challenging, particularly when dealing with large and diverse datasets. Coordinating different components, such as language models, data retrieval systems, and ontologies, to facilitate seamless operation and data exchange across interconnected systems, while addressing issues with performance enhancement and integration across various operational layers, can also present complexities.

The technical solutions described herein can implement a computing architecture configured to utilize a multi-stage natural language processing pipeline to optimize user input processing. For example, when receiving user inputs via a chatbot interface for generating an electronic report, the large language model (LLM) may encounter challenges with ambiguous queries, leading to incorrect interpretations or responses. To address the inherent ambiguity of natural language, the computing architecture can integrate a generative AI model to reformulate ambiguous queries into more precise and unambiguous forms. This reformulation process can improve the LLM's ability to accurately interpret user intent. For example, the intent sentence can provide the LLM with a clear understanding of the desired outcome or action within the context of the electronic report, thereby improving the relevance and accuracy of the generated output.

Moreover, insufficient domain-specific knowledge can further limit the LLM's ability to generate accurate responses. The technical solutions can incorporate an ontology-driven approach. For example, an ontology, a formal representation of domain concepts, can be utilized to provide the LLM with a structured understanding of the relevant domain. In this regard, the computing architecture can filter the ontology by extracting domain-specific elements, intents, and examples. By narrowing the scope to the filtered subset of the ontology, the computing architecture can reduce computing resource utilization while improving the accuracy and reliability of the LLM's responses. For example, these extracted entities can be used to refine the LLM's responses by providing the LLM with more relevant information and maintaining alignment with the established domain-specific structures, relationships, and rules. Additionally, the implementation of few-shot learning techniques can further enhance the LLM's ability to generate outputs that adhere to the domain-specific constraints with limited training data. For example, the few-shot learning techniques can allow the LLM to learn and adapt to new information more effectively, improving its performance and accuracy in specific domains.

Furthermore, the technical solutions described herein can improve user experience and interaction via the chatbot interface configured to streamline report navigation and modification. For example, the chatbot interface can dynamically display relevant fields of an electronic report to facilitate efficient interaction, including filtering options, report modifications, and data entry, among others. Upon receiving user input, the computing architecture can dynamically adjust the electronic report structure and present the updated content in real-time or near real-time via a separate reporting interface, which is decoupled from the chatbot interface. This decoupling of the chatbot interface and reporting interface provides a seamless and engaging user experience, allowing users to interact with the chatbot and view the modified report simultaneously.

An aspect of this disclosure can be directed to a system. The system can include one or more processors, coupled with memory. The system can receive, via a chatbot interface, a textual input related to an electronic report. The system can generate, in response to the textual input, using a large language model, an output including a set of keywords, a rephrased version of the textual input, and an intent sentence. The system can filter, using the output from the large language model, an ontology stored in a database to generate a filtered ontology including one or more ontology elements, intents, and examples. The system can generate, using the large language model and the filtered ontology, a list of actions that are executable to modify the electronic report. The system can display, via the chatbot interface, the list of actions. The system can receive, via the chatbot interface, an indication to execute an action from the list of actions. The system can provide, responsive to the indication, instructions to execute the action associated with the electronic report to modify the electronic report.

The chatbot interface can be decoupled from a reporting interface displaying the electronic report. The system can determine, in response to receiving the textual input, a user identifier and a state of the electronic report. The state of the electronic report can correspond to an initial state of the electronic report prior to any modifications being made to the electronic report. The system can provide the textual input, the user identifier, and the state of the electronic report to the large language model to cause the large language model to generate the output. The system can generate a search query based on the set of keywords, the rephrased version of the textual input, and the intent sentence. The system can provide the search query to a search engine to identify the one or more ontology elements, the intents, and the examples. The system can generate an input context based on the filtered ontology. The system can provide the input context to the large language model to cause the large language model to generate the list of actions. The ontology can include a resource description framework including a plurality of nodes. Each node of the plurality of nodes can include a plurality of attributes. The node can be associated with a probability score based on a relative frequency of one or more attribute combinations in historical data maintained in the database. Each action from the list of actions can correspond to a respective field of the electronic report.

An aspect of this disclosure can be directed to a method. The method can include receiving, via a chatbot interface, a textual input related to an electronic report. The method can include generating, in response to the textual input, using a large language model, an output including a set of keywords, a rephrased version of the textual input, and an intent sentence. The method can include filtering, using the output from the large language model, an ontology stored in a database to generate a filtered ontology including one or more ontology elements, intents, and examples. The method can include generating, using the large language model and the filtered ontology, a list of actions that are executable to modify the electronic report. The method can include displaying, via the chatbot interface, the list of actions. The method can include receiving, via the chatbot interface, an indication to execute an action from the list of actions. The method can include providing, responsive to the indication, instructions to execute the action associated with the electronic report to modify the electronic report.

The chatbot interface is decoupled from a reporting interface displaying the electronic report. The method can include determining, in response to receiving the textual input, a user identifier and a state of the electronic report. The state of the electronic report can correspond to an initial state of the electronic report prior to any modifications being made to the electronic report. The method can include providing the textual input, the user identifier, and the state of the electronic report to the large language model to cause the large language model to generate the output. The method can include generating a search query based on the set of keywords, the rephrased version of the textual input, and the intent sentence. The method can include providing the search query to a search engine to identify the one or more ontology elements, the intents, and the examples. The method can include generating an input context based on the filtered ontology. The method can include providing the input context to the large language model to cause the large language model to generate the list of actions. The ontology can include a resource description framework including a plurality of nodes. Each node of the plurality of nodes can include a plurality of attributes. The node can be associated with a probability score based on a relative frequency of one or more attribute combinations in historical data maintained in the database.

An aspect of this disclosure can be directed to a non-transitory computer readable medium, including one or more instructions stored thereon and executable by a processor. The processor can receive, via a chatbot interface, a textual input related to an electronic report. The processor can generate, in response to the textual input, using a large language model, an output including a set of keywords, a rephrased version of the textual input, and an intent sentence. The processor can filter, using the output from the large language model, an ontology stored in a database to generate a filtered ontology including one or more ontology elements, intents, and examples. The processor can generate, using the large language model and the filtered ontology, a list of actions that are executable to modify with the electronic report. The processor can display, via the chatbot interface, the list of actions. The processor can receive, via the chatbot interface, an indication to execute an action from the list of actions. The processor can provide, responsive to the indication, instructions to execute the action associated with the electronic report to modify the electronic report.

### BRIEF DESCRIPTION OF THE DRAWINGS

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system, in accordance with some implementations.

FIG. 2 depicts an example operational system, in accordance with some implementations.

FIGS. 3-4 depict an example chatbot interface, in accordance with some implementations.

FIG. 5 depicts an example reporting interface, in accordance with some implementations.

FIG. 6 depicts an example ontology, in accordance with some implementations.

FIG. 7 depicts example probability scores associated with concepts, in accordance with some implementations.

FIG. 8 depicts an example ontology of core concepts related to report intents, in accordance with some implementations.

FIGS. 9-11 depict an example ontology mapping, in accordance with some implementations.

FIG. 12 depicts an example operational system integrating a serverless platform, in accordance with some implementations.

FIG. 13 depict an example method of data structure modification using a virtual assistant based on large language models and ontology, in accordance with some implementations.

FIG. 14 depicts a block diagram of an example computing system for implementing the embodiments of the present solution, including, for example, the systems depicted in FIGS. 1-2 and 12, and the method depicted in FIG. 13.

### DETAILED DESCRIPTION

Aspects of the technical solutions are described herein with reference to the figures, which are illustrative examples of this technical solution. The figures and examples below are not meant to limit the scope of the technical solutions to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, the technical solutions and the present implementations encompass present and future known equivalents to the known components referred to herein by way of description, illustration, or example.

The technical solutions described herein can implement a multi-stage natural language processing pipeline to enhance user input processing for generating electronic reports via a chatbot interface. When a user provides textual input, the large language model (LLM) can generate a set of keywords, a rephrased version of the input, and an intent sentence to clarify the user's request. This output can be used to filter an ontology stored in a database, generating a filtered ontology that includes relevant ontology elements, intents, and examples. Based on filtered ontology, the system can cause the LLM to generate a plurality of actions compatible with the report, which can be displayed through the chatbot interface. Each action can be associated with corresponding formatting instructions. Upon receiving an indication to execute one of the actions, the system can dynamically execute the corresponding formatting instructions and present the modified electronic report in real-time or near real-time via a decoupled reporting interface. The computing architecture can provide efficient interaction, real-time report modification, and a seamless user experience, enhanced by few-shot learning techniques to maintain domain-specific accuracy with minimized training data.

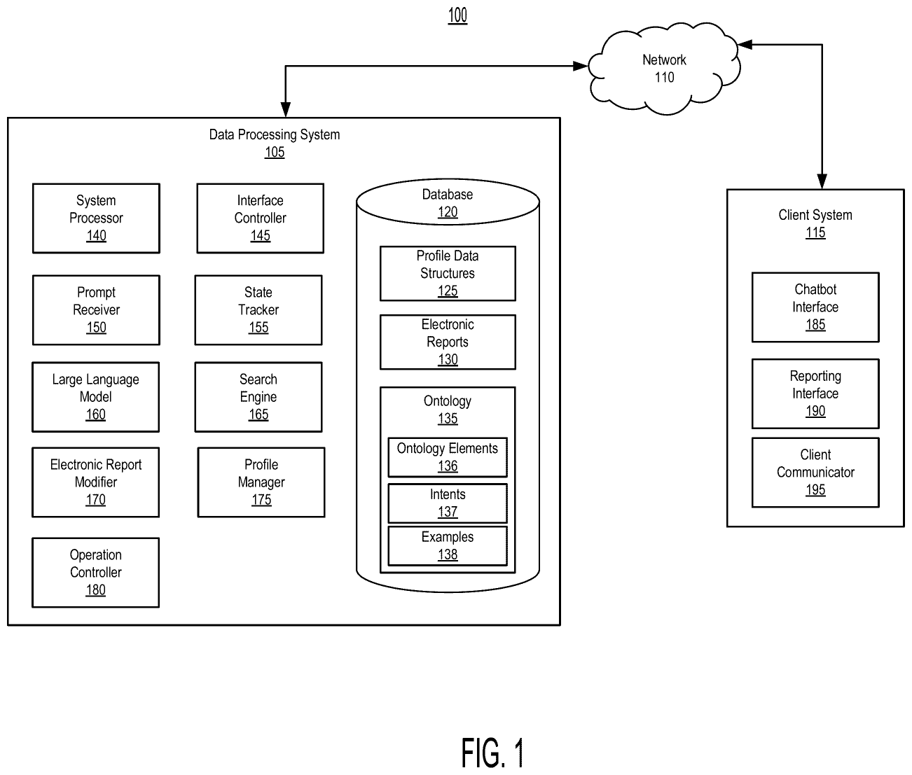

FIG. 1 depicts an example system, according to this disclosure. As illustrated by way of example in FIG. 1, a system 100 can include one or more of a data processing system 105 and a client system 115. One or more components of the system 100 can communicate via network 110.

The data processing system 105 can include a physical computer system operatively coupled or coupleable with one or more components of the system 100. The data processing system 105 can include, host, or be hosted by or on a cloud system, a server, a distributed remote system, or any combination thereof. The data processing system 105 can include a virtual computing system, an operating system, and a communication bus to effect communication and processing. The data processing system 105 can include physical infrastructure, such as physical servers, storage devices, and network equipment housed in data centers. The data processing system 105 can include a virtual computing system, which can include cloud-based virtual machines or containers for running applications and services. The data processing system 105 can include an operating system that can function as the core manager, allocating resources, configuring processes, and maintaining seamless interaction between hardware and applications. The data processing system 105 can include a communication bus that can facilitate communication between different components within the system. The data processing system 105 can be configured to connect with external systems to allow for data exchange and service delivery to end users.

The network 110 can include any type or form of network. The geographical scope of the network 110 can vary widely and the network 110 can include a body area network (BAN), a personal area network (PAN), a local-area network (LAN), e.g., Intranet, a metropolitan area network (MAN), a wide area network (WAN), or the Internet. The topology of the network 110 can be of any form and can include, e.g., any of the following: point-to-point, bus, star, ring, mesh, or tree. The network 110 can include an overlay network which is virtual and sits on top of one or more layers of other networks 110. The network 110 can be of any such network topology as known to those ordinarily skilled in the art capable of supporting the operations described herein. For example, the network 110 can be any form of computer network that can relay information between the data processing system 105 and the client system 115. The network 110 can utilize different techniques and layers or stacks of protocols, including, e.g., the Ethernet protocol, the Internet protocol suite (TCP or IP), the ATM (Asynchronous Transfer Mode) technique, the SONET (Synchronous Optical Networking) protocol, or the SD (Synchronous Digital Hierarchy) protocol. The TCP or IP Internet protocol suite can include application layer, transport layer, Internet layer (including, e.g., IPv6), or the link layer. The network 110 can include a type of a broadcast network, a telecommunications network, a data communication network, or a computer network.

The client system 115 (also referred to herein as a client device 115) can include a computing system that can be used to access the functionality of the data processing system 105. The client system 115 can include a smart phone, mobile device, laptop computer, desktop computer, one or more servers, or any other type of computing device. The client system 115 can include at least one processor and a memory, e.g., a processing circuit. The memory can store processor-executable instructions that, when executed by the processor, cause the processor to perform one or more of the operations described herein. The processor can include a microprocessor, an ASIC, an FPGA, etc., or combinations thereof. The memory can include, but is not limited to, electronic, optical, magnetic, or any other storage or transmission device capable of providing the processor with program instructions. The memory can further include a floppy disk, CD-ROM, DVD, magnetic disk, memory chip, ASIC, FPGA, ROM, RAM, EEPROM, EPROM, flash memory, optical media, or any other suitable memory from which the processor can read instructions. The instructions can include code from any suitable computer programming language.

The client system 115 can include one or more devices to receive input from a user or to provide output to a user. For example, the output capabilities of the client system 115 can be presented through a display device that provides visual feedback to the user. The display device can enhance the user experience with electronic displays, such as liquid crystal displays (LCD), light-emitting diode (LED) displays, or organic light-emitting diode (OLED) displays. The electronic displays can implement interactive features, including capacitive or resistive touch input, allowing for multi-touch functionality. The input functionalities can include a keyboard, mouse, or an integrated touch-sensitive panel on the display device, but are not limited thereto.

Each client device 115 can be associated with an identifier used to identify devices or user profiles operating the client devices 115. The identifier can be of one or more forms, such as a device ID, which can be a code assigned to the client device 115 by the manufacturer or operating system, a MAC address, which can be a hardware address assigned to the client device's network interface, or an IP address, which can identify the client device 115 on a network. The identifier can be a user ID associated with the user profile operating the client device 115, or a session ID, which can be a temporary identifier assigned to a specific session. Other identifiers, such as a serial number, can be used depending on the system and device configuration.

The client system 115 can execute an application that communicates with the data processing system 105. The application can present one or more chatbot interfaces 185. The chatbot interface 185 can include a set of rules or protocols that allow different software programs or systems to communicate with each other. The chatbot interface 185 can provide user interfaces to facilitate interaction. For example, the chatbot interface 185 can support text-based interactions or voice-based interactions. Users can input information, view content, or initiate actions through the chatbot interface 185. In some implementations, the chatbot interface 185 can be associated with a particular client application that communicates with the data processing system 105 to process user prompts. The client application can include an application executing on each client system 115. The client application can include a web application, a server application, a resource, a desktop, or a file. In some embodiments, the client application can include a local application (e.g., local to a client system 115), a hosted application, a software-as-a-service (SaaS) application, a virtual application, a mobile application, and other forms of content. In some embodiments, the client application can include or correspond to applications provided by remote servers or third-party servers.

The chatbot interface 185 can be decoupled from a reporting interface 190 that displays an electronic report 130. Decoupling the chatbot interface 185 from the reporting interface 190 can refer to the chatbot interface 185 operating as a plug-in or an embedded component, allowing the chatbot interface 185 to operate independently from the reporting interface 185. In some embodiments, the chatbot interface 185 can operate within an inline frame (iFrame), an HTML element that loads a separate HTML page within the parent webpage, effectively embedding one webpage within another while maintaining separate functionalities. For example, the chatbot interface 185 can be loaded and displayed within the reporting interface 190, while still maintaining its own functionality and independence. In some embodiments, decoupling can include the chatbot interface 185 and the reporting interface 190 being implemented as separate applications that can communicate through interface controller 145, APIs, or other messaging protocols. In some embodiments, the chatbot interface 185 and the reporting interface 190 can be integrated within a larger application while still maintaining a modular structure. In some embodiments, the system 100 can employ a component-based architecture, where the chatbot interface 185 and the reporting interface 190 can be implemented as separate components that can be customized as desired.

The chatbot interface 185 can parse the data structure generated by the large language model 160 to present corresponding actions. The chatbot interface 185 can evaluate the structure of data, such as the format (e.g., JSON, XML, or CSV) and the organization of elements (e.g., classes, properties, and individuals). The chatbot interface 185 can extract relevant information from the data structure based on indicators that indicate actions, such as verbs or commands. The chatbot interface 185 can display the extracted actions into a suitable display format, such as lists, buttons, or dropdown menus. The chatbot interface 185 can receive an indication to execute an action from the user in various forms. For example, the indication can include a button click, where the user clicks on a button associated with the corresponding action, or a menu selection, where the user selects an action from a dropdown menu or a list of options. The chatbot interface 185 can transmit the indications to the data processing system 105 or the reporting interface 190.

The client system 115 can include, interface with, communicate with, or otherwise utilize a reporting interface 190. The reporting interface 190 can present one or more electronic reports 130, such as payroll summaries, employee earnings statements, tax forms, time and attendance records, or compliance reports, among others. The reporting interface 190 can provide customizable displays that adapt to different types of applications and devices. The reporting interface 190 can be integrated into various environments. For example, the reporting interface 190 can be embedded in a web application, allowing users to view electronic reports 130 through a browser interface. The reporting interface 190 can be integrated into a desktop application, displaying electronic reports 130 locally on the client system 115. The reporting interface 190 can be deployed within a mobile application, presenting electronic reports 130 in a format suitable for smaller screens and touch interactions. The reporting interface 190 can operate within a software-as-a-service (SaaS) platform, where electronic reports 130 are hosted remotely but accessed and displayed through the client system 115. The reporting interface 190 can integrate with third-party applications or systems, allowing electronic reports 130 to be displayed from external sources (e.g., human resources management systems).

The client system 115 can include, interface with, communicate with, or otherwise utilize a client communicator 195. The client communicator 195 within the client system 115 can be similar to, and include any of the structure and functionality of, the interface controller 145 described in connection with the data processing system 105. For example, the client communicator 195 within the client system 115 can communicate with the data processing system 105 via the network 110 using one or more communication interfaces to carry out the various operations described herein. The client communicator 195 can be compatible with particular content objects and can be compatible with particular content delivery systems corresponding to particular content objects, structures of data, types of data, or any combination thereof.

The data processing system 105 can include, interface with, communicate with, or otherwise utilize a database 120. The database 120 can be a computer-readable memory that can store or maintain any of the information described herein. The database 120 can store data associated with the system 100. The database 120 can include one or more hardware memory devices to store binary data, digital data, or the like. The database 120 can include one or more electrical components, electronic components, programmable electronic components, reprogrammable electronic components, integrated circuits, semiconductor devices, flip flops, arithmetic units, or the like. The database 120 can include at least one of a non-volatile memory device, a solid-state memory device, a flash memory device, or a NAND memory device. The database 120 can include one or more addressable memory regions disposed on one or more physical memory arrays. A physical memory array can include a NAND gate array disposed on, for example, at least one of a particular semiconductor device, an integrated circuit device, or a printed circuit board device. In an aspect, the database 120 can correspond to a non-transitory computer readable medium. In an aspect, the non-transitory computer readable medium can include one or more instructions executable by a system processor 140.

The database 120 can store or maintain one or more data structures, which can include containers, indices, or otherwise store each of the values, pluralities, sets, variables, vectors, numbers, or thresholds described herein. The database 120 can be accessed using one or more memory addresses, index values, or identifiers of any item, structure, or region maintained in the database 120. The database 120 can be accessed by the components of the data processing system 105, the client system 115, or any other computing device described herein, via the network 110. The database 120 can be internal to the data processing system 105. The database 120 can exist external to the data processing system 105 and can be accessed via the network 110. For example, the database 120 can be distributed across many different computer systems (e.g., a cloud computing system) or storage elements and can be accessed via the network 110 or a suitable computer bus interface.

The database 120 can store or maintain one or more profile data structures 125. The profile data structure 125 can include a structured representation of an entity (e.g., user, product, or system). For example, the profile data structure 125 associated with a user profile can include payroll-related data, such as personal details (e.g., name, address, social security number, date of birth), employment information (e.g., job title, hire date, department, work location), compensation data (e.g., salary, hourly wage, overtime rate, bonuses, commissions), tax information (e.g., federal, state, and local tax withholdings, exemptions, deductions), benefits data (e.g., health insurance, retirement plans, paid time off, disability insurance), time tracking details (e.g., hours worked, overtime, sick leave, vacation time), payroll deductions (e.g., contributions to retirement plans, health insurance premiums, union dues, garnishments), deposit information (e.g., bank account details for paycheck deposits), performance assessments (e.g., annual evaluations, competency assessments, goal achievements), termination records (e.g., termination date, reason for termination, severance details), and government reporting data (e.g., forms like W-2, 1099), among others.

The profile data structure 125 can include attributes with specific data types (e.g., name: string, salary: decimal). Each attribute can have a specific data type, such as a string, integer, date, or Boolean. The profile data structure 125 can organize entities in a hierarchical structure, where one entity acts as a parent to multiple child entities (e.g., a company profile having a hierarchical relationship with department profiles, and department profiles having hierarchical relationships with employee profiles). The profile data structure 125 can include metadata such as creation date, modification timestamps, data source, and ownership, among others. The profile data structure 125 can be associated with other data structures or entities via identifiers, such as an employee ID or a social security number. The identifier can associate the profile data structure 125 with corresponding records, providing access to related information for querying and data retrieval.

The profile data structure 125 can include relationships with other data structures to indicate connections or associations between entities. The relationships can be of various types, such as one-to-one, where a single instance of one entity is associated with a single instance of another entity (e.g., a user profile having a one-to-one relationship with a login profile). The relationships can also be one-to-many, where a single instance of one entity is associated with multiple instances of another entity (e.g., a department profile having a one-to-many relationship with employee profiles). In some cases, the relationships can be many-to-many, where multiple instances of one entity are associated with multiple instances of another (e.g., a project profile having a many-to-many relationship with employee profiles to indicate which employees are assigned to the project).

The database 120 can store or maintain one or more electronic reports 130. The electronic reports 130 can correspond to digital documents that present data in a structured format for displaying payroll, financial, or compliance records, among others. The electronic reports 130 can be generated and accessed on various client devices 115, such as desktop computers, mobile devices, or web-based applications, depending on the implementation. The format of an electronic report can vary based on the intended use and accessibility requirements. For example, the electronic reports 130 can be generated in Portable Document Format (PDF) for compatibility across devices while maintaining a fixed layout, or in Excel format to facilitate data manipulation and analysis. In some embodiments, an electronic report can be rendered in Hypertext Markup Language (HTML) for interactive web-based displays, allowing real-time or near real-time access and user interaction. In some embodiments, Extensible Markup Language (XML) can be used for data interchange between systems. In web-based applications, Javascript Object Notation (JSON) can be used for lightweight data interchange. The electronic reports 130 can be used in online display contexts where users can dynamically filter, sort, and interact with report data in real time or near real-time. The electronic reports 130 can include links or embedded elements that allow users to navigate to specific data points or generate custom views.

The database 120 can store or maintain one or more domain specific ontologies 135. An ontology 135 can be a structured framework that defines relationships and categories of concepts within a specific domain. The ontologies 135 can capture relevant concepts, terms, and relationships using structured formats, such as knowledge graphs or semantic networks. The ontology 135 can be based on the resource description framework (RDF), a standard model for data interchange on the web. The RDF can facilitate the representation of data about resources in a structured, machine-readable format. For example, the RDF can include one or more components, such as a subject (e.g., the resource being described), a predicate (e.g., the property or relationship of the resource), and an object (e.g., the value or another resource related to the subject). The ontologies 135 can be extended to incorporate additional concepts, relationships, or instances as the domain evolves. Additionally, ontologies 135 can facilitate interoperability between systems and applications by providing a common vocabulary and understanding of concepts.

The ontology 135 can be structured as a graph or network composed of nodes and relationships between them. Each node can specify a concept, entity, or individual within the defined domain, while relationships (also known as edges or links) can define the connections between nodes. Each node can be associated with attributes that specify the respective properties or characteristics. For example, a user profile within the ontology can include one or more nodes. The user profile can include a payroll name node and a legal name node. Each of these nodes can be associated with attributes such as first name, middle name, and last name.

Each node can be associated with a probability score that indicates the likelihood of a particular attribute combination occurring. The probability score can be calculated based on the relative frequency of the attribute combination in historical data stored in the database 120. For example, the payroll name node may have a higher probability score for the combination of “John” and “Smith” if this combination frequently appears in past payroll records, or vice versa. Similarly, the legal name node for the same user profile may have a higher probability score for the combination of “Jonathan” and “Smythe” if this combination is commonly found in legal documents, or vice versa. In some embodiments, the order of the attributes can be changed. For instance, the combination of a first name and last name can be associated with the legal name node or the payroll name node. For example, “Smith, John” (last name followed by first name) may be more common in payroll-related categories, and “John Smith” (first name followed by last name) may be more common in legal categories, or vice versa. These patterns can vary depending on regional or organizational factors.

The ontology 135 can include one or more ontology elements 136 relevant to the specific domain, such as payroll or financial data. The ontology elements 136 can define various domain aspects, including classes, properties, individuals, and axioms, among others. The classes can include employee name, department, job, pay grade, and benefit, among others. The properties can define relationships between classes, such as the relationship between an employee and a department, or between an employee and their salary or benefits. The individuals can indicate specific instances, such as a particular employee, a specific department, a job role, a pay grade, or a benefit plan. The axioms can establish rules and constraints within the ontology, such as limiting an employee to only one department or determining an employee's salary based on their job and pay grade. For example, an ontology direct to payroll can include a class for employees with properties such as name, employee ID, department, and salary, where the department property connects to a class for departments and the salary property connects to a class for pay grades. The axioms can further specify that an employee belongs to a single department and their salary is determined by their job and pay grade.

The ontology 135 can include one or more intents 137. The intents 137 can specify how users combine core concepts and how each combination is identified. The intents 137 can correspond to high-level goals or objectives that users may have when interacting with a system, such as generating reports or performing calculations to display relevant data. In the context of a natural language processing system, the intents 137 can indicate the underlying user intent behind a query or prompt. Each intent 137 can be specific enough to distinguish between different user requests or actions within the system. The intents 137 can include possible user actions related to generating reports or performing calculations within the domain. For example, in the human resources domain, the intents 137 can include actions such as generating a report of employee information or retrieving contact details. In the payroll domain, the intents 137 can include viewing pay stubs, generating tax forms, or generating payroll summaries. The benefits-related intents 137 can include generating reports to view benefits eligibility or benefits enrollment history. The time management intents 137 can include viewing timecard summaries, generating a report of requested time off, or calculating work hours. The recruitment intents 137 can include generating reports of job openings or reviewing applications based on retrieved data. The talent management intents 137 can involve generating performance review summaries or calculating training completion statistics. The learning-related intents 137 can include generating reports of completed training courses or certifications. The above list of intent examples is not exhaustive and can include or cover additional domains depending on the implementation.

The intent 137 can include actions related to customizing electronic reports 130. For example, the intents 137 can correspond to adding new fields to display additional data not currently included in the electronic report 130. The intents 137 can support modifying existing fields to change the format or content of fields. The intents 137 can include filtering data to display relevant data based on defined criteria, such as date ranges, employee roles, or departmental information. The intents 137 can include sorting data to organize report content in a specific order, such as ascending or descending values, or by predefined categories. The intents 137 can further involve actions such as aggregating data for summary views or generating dynamic sections within the electronic report 130 to accommodate different levels of detail.

The ontology 135 can include examples 138. The examples 138 can associate user inputs with corresponding responses based on inferred intents. The examples 138 can specify how to interpret different user inputs and match them with relevant actions. For example, the user input “Sort employees by salary” can be associated with the intent “sort data”, with the corresponding output response being “I'll add that to your report”. Another example can include the input “Show me only single and active employees”, associated with the intent “filter data”, with the corresponding output response being “Okay, I'll list single and active employees”, indicating the action to filter data based on specific criteria. More complex interactions can include the input “Request a leave of absence”, associated with the intent “submit leave request”, with the corresponding output response being “Please provide the start and end dates for the leave”. In another example, the input “Enroll in the new health insurance plan” can be associated with the intent “enroll in benefits”, with the corresponding output response being “Your enrollment has been confirmed, and additional details will be provided”. These examples 138 can dynamically adapt to changing user needs, intents, and data contexts.

The ontology 135, including ontology elements 136, intents 137, and examples 138, can be used for few-shot learning to dynamically train a large language model 160. For example, the large language model 160 can be trained on a limited number of examples to generate accurate responses. Few-shot learning can refer to or include a machine learning technique that allows machine learning models to learn from a limited number of examples. By leveraging the ontology, the large language model 160 can effectively learn and generate accurate responses, even with a small dataset. The ontology elements 136 can include classes, properties, individuals, axioms, and annotations, which can define sets of individuals with shared characteristics, describe relationships between classes, indicate specific instances of classes, and provide metadata for additional context. The intents 137 can specify high-level goals or objectives that users may have, such as generating reports or querying specific data. The examples 138 can provide input-output pairs, indicating how the large language model 160 can respond to specific prompts. Based on ontology 135, the large language model 160 can learn to effectively process and respond to queries related to the domain.

The data processing system 105 can include, interface with, communicate with, or otherwise utilize a system processor 140. The system processor 140 can be or include any script, file, program, application, set of instructions, or computer-executable code that can be configured to execute one or more instructions associated with the data processing system 105. The system processor 140 can include an electronic processor, an integrated circuit, or the like, including one or more of digital logic, analog logic, digital sensors, analog sensors, communication buses, volatile memory, nonvolatile memory, and the like. The system processor 140 can include, but is not limited to, at least one microcontroller unit (MCU), microprocessor unit (MPU), central processing unit (CPU), graphics processing unit (GPU), physics processing unit (PPU), embedded controller (EC), or the like. The system processor 140 can include a memory operable to store one or more instructions for operating components of the system processor 140 and operating components operably coupled to the system processor 140. For example, the one or more instructions can include one or more of firmware, software, hardware, operating systems, or embedded operating systems. The system processor 140 or the data processing system 105 generally can include one or more communication bus controllers to effect communication between the system processor 140 and the other elements of the data processing system 105.

The data processing system 105 can include, interface with, communicate with, or otherwise utilize an interface controller 145. The interface controller 145 can be or include any script, file, program, application, set of instructions, or computer-executable code that can be configured to facilitate communication between the data processing system 105 and the client system 115. The interface controller 145 can include hardware, software, or any combination. The interface controller 145 can facilitate communication between the data processing system 105, the network 110, or the client system 115 via one or more communication interfaces. A communication interface can include, for example, an application programming interface (“API”) compatible with a particular component of the data processing system 105 or the client system 115. The communication interface can provide a particular communication protocol compatible with a particular component of the data processing system 105 or a particular component of the client system 115. The interface controller 145 can be compatible with particular content objects and can be compatible with particular content delivery systems corresponding to particular content objects, structures of data, types of data, or any combination thereof. For example, the interface controller 145 can be compatible with the transmission of structured or unstructured data according to one or more metrics.

The data processing system 105 can include, interface with, communicate with, or otherwise utilize a prompt receiver 150. The prompt receiver 150 can be or include any script, file, program, application, set of instructions, or computer-executable code that can be configured to process input data in the form of a message, query, or prompt. The prompt receiver 150 can include hardware, software, or any combination thereof. The input data can include any user-provided command, request, or text data. The prompt receiver 150 can receive textual inputs from the client system 115 in natural language (e.g., a text string) and process textual inputs through user interactions with the chatbot interface 185. User interactions can include clicking buttons, entering text, or using voice commands within the chatbot interfaces 185. The prompt receiver 150 can expose an API endpoint, allowing other applications or systems to send prompts in structured formats such as JSON, facilitating tasks related to payroll or other system interactions. The prompt receiver 150 can identify textual inputs related to a specific electronic report 130 by extracting or receiving an associated identifier, such as a report ID or metadata embedded within the input.

The prompt receiver 150 can generate a search query for a search engine 165 based on a set of extracted keywords, a rephrased version of a textual input, and an intent sentence. An intent sentence can be a concise statement that captures the underlying goal or objective of a user's query or request. The intent sentence can provide an unambiguous summary of the user's desired outcome. For example, given the user query, “Can you show me a list of employees who earn more than $50,000 per year in the sales department?” the intent sentence can correspond to “Find employees in the sales department with a salary greater than $50,000”. The intent sentence can facilitate the query processing by focusing on or understanding the specific objective of the query, such as adding, filtering, or sorting relevant data to satisfy the user's request.

The prompt receiver 150 can combine the extracted keywords into a unified search query string and apply logical operators such as AND, OR, or NOT to define relationships between different keywords. The prompt receiver 150 can include the rephrased version of the textual input as an additional keyword or query term. The prompt receiver 150 can apply intent-based modifications to the search query by adding specific terms or phrases that align with the identified intent. The prompt receiver 150 can adjust the structure of the query to specify the desired behavior, such as filtering, sorting, or grouping. The prompt receiver 150 can apply search operators such as proximity operators or wildcard characters to refine the scope and precision of the search query. In a non-limiting example, the prompt receiver 150 can generate a search query by combining the keywords, such as “employee”, “salary”, “department”, and “sales” into a structured query. The prompt receiver 150 can include the rephrased version of the textual input, “What is the average salary for employees in the sales department?” to provide additional context for the search. The prompt receiver 150 can modify the search query based on the intent sentence, “Find the average salary of employees in a specific department”, by applying appropriate terms and refining the query structure. For example, the search query can be constructed as, “Find average salary for employees AND department=sales”.

The prompt receiver 150 can generate an input context for the large language model 160. The input context can be based on the filtered ontology, which includes relevant ontology elements 136, intents 137, and examples 138. The large language model 160 can use the input context to generate actions compatible with the electronic report 130, such as formatting instructions for an electronic report modifier 170 of the data processing system 105 to modify the electronic report 130. Each action can correspond to a respective field of the electronic report 130. For example, actions can be mapped to specific fields, such as employee information, net pay, pay period, and total sales, among others. The actions can include or correspond to operations that can be executed based on interaction with interactive elements that a user can interact with. Upon interacting with any of the interactive elements, the data processing system 105 can execute corresponding instructions to dynamically modify the associated report structure, such as adding or removing fields, changing data types, or rearranging the layout, among others. For example, if a user interacts with an action “total sales by region”, the data processing system 105 can execute the corresponding instructions to filter the electronic report 130 by region, for instance, and apply a calculation to display total sales according to a set of formatting instructions. In another example, if a user interacts with an action “calculate net pay by department”, the data processing system 105 can execute the corresponding instructions to filter the payroll report by department and apply calculations to display the net pay for one or more user profiles within that department according to a set of formatting instructions. The formatting instructions can be predetermined or generated at runtime.

The data processing system 105 can include, interface with, communicate with, or otherwise utilize a state tracker 155. The state tracker 155 can be or include any script, file, program, application, set of instructions, or computer-executable code that can be configured to track the status and version history of electronic reports 130 throughout their lifecycle. The state can correspond to an initial state of the electronic report 130 prior to any modifications being made to the electronic report 130. The initial state can include the electronic report's original content, structure, and metadata before any edits, updates, or external inputs are applied. The state tracker 155 can monitor the generation and storage of electronic reports 130. The state tracker 155 can assign version numbers to differentiate each iteration of the electronic report 130. The state tracker 155 can maintain change logs to document what changes were made, who made them, and when they were made. The state tracker 155 can implement file naming conventions to identify a particular version. The state tracker 155 can utilize version control tables to list all versions, changes, and relevant details of an electronic report 130. The state tracker 155 can archive older versions of electronic reports 130 while keeping them accessible for reference. The state tracker 155 can automatically update version numbers and log changes when a subsequent version of the electronic report 130 is generated.

The data processing system 105 can include, interface with, communicate with, or otherwise utilize a large language model 160. The large language model 160 can perform a variety of text processing tasks, including, but not limited to, generating text, formatting instructions, comprehending and processing natural language input, and responding to prompts with contextually relevant information. The large language model 160 can include a transformer architecture, such as a generative pre-trained transformer (GPT) architecture. The transformer architecture can include an encoder that can process the input text and a decoder that can generate the output text. The large language model 160 can include multiple layers that can operate to process and generate text. For example, embedding layers can convert words or tokens into dense vectors of fixed size, attention layers can use mechanisms such as self-attention to weigh the importance of different tokens in a sequence, and feedforward layers can apply transformations to the data to learn complex patterns. The large language model 160 can use a self-attention mechanism to weight different parts of the input sequence when generating predictions. The large language model 160 can determine one or more properties of an input prompt that correspond to natural language. Natural language input can have a syntactic structure in which individual words, collections of words (e.g., phrases), or relative positions of words (e.g., word order) can indicate specific meanings. The large language model 160 can parse sentences into their grammatical components to understand the structure and relationships between words. The large language model 160 can use phrasing structure rules that define how words combine to form phrases and sentences.

The large language model 160 can process textual input, user identifiers, and the state of the electronic report 130 to generate corresponding outputs. The large language model 160 can perform input analysis by identifying relevant keywords from the textual input, evaluating the context within the electronic report 130, and referencing user preferences or interaction history. The large language model 160 can evaluate the textual input to determine the underlying intent of a user, such as the specific action the user seeks to accomplish within the electronic report 130. Based on the analysis, the large language model 160 can generate one or more outputs, such as a list of keywords sorted by relevance, a more objective rephrased version of the textual input, and an intent sentence that provides a summary of the underlying report intent. For example, if the textual input is “show employees with salaries above $50,000”, the large language model 160 can generate a keyword list including “employees”, “salaries”, and “above $50,000”, a rephrased input such as “display employees earning more than $50,000”, and an intent sentence such as “filter employee list by salary threshold”.

The large language model 160 can generate a set of formatting instructions associated with each candidate action. These formatting instructions can be structured in formats such as JSON or XML, defining specific modifications to the electronic report 130. The structured format can specify field modifications, layout changes, and formatting rules, allowing the data processing system 105 to implement modifications such as adding or removing fields, changing data types, or applying custom formatting, among others. In some embodiments, a template-based approach can be used, where formatting instructions can be based on predefined templates that define the structure and content of the electronic report 130. The large language model 160 can generate instructions to modify elements within the template, such as adding or removing fields, changing data types, or applying formatting rules.

The data processing system 105 can include, interface with, communicate with, or otherwise utilize a search engine 165. The search engine 165 can be or include any script, file, program, application, set of instructions, or computer-executable code that can be configured to process queries and retrieve relevant information from the database 120. A query can be a structured command or statement used to retrieve data stored in the database 120. The search engine 165 can process queries by parsing them into individual tokens, normalizing the tokens (e.g., parts of the query) to a standard form, and applying stemming or lemmatization to reduce words to their root forms. The search engine 165 can search an index, which can be a structured database of crawled and indexed content. The search engine 165 can perform an index lookup to identify potential search results corresponding to the query terms. The search engine 165 can apply Boolean operations to refine search results based on query structure. The search engine 165 can rank the potential matches based on relevance, using factors such as keyword relevance, content quality, and user engagement, among others. The search engine 165 can generate snippets to summarize each result and format the results in a layout that includes related searches.

The search engine 165 can utilize a search query generated based on a set of keywords, a rephrased version of the textual input, and an intent sentence. The search engine 165 can filter the ontology 135 stored in the database 120 based on the search query. The search engine 165 can apply the search query to the ontology to generate a filtered ontology by extracting one or more relevant ontology elements 136, intents 137, and examples 138. For example, the filtered ontology can include specific ontology elements 136, such as classes, properties, individuals, axioms, and annotations that are related to the search query. The search engine 165 can identify intents 137, which specify high-level objectives associated with the search query. The search engine 165 can extract relevant examples 138, which include specific output responses that match the search criteria. For example, if the search query is “find all employees in the sales department”, the filtered ontology can include ontology elements, such as “Employee” and “Department”. The search engine 165 can identify intents corresponding to employee details, such as “find employee details” or “view employee performance”. The search engine 165 can provide examples, where an input of “Show all employees in sales” corresponds to an output of “Displaying all employees in the sales department, including name, job title, and salary.”

The data processing system 105 can include, interface with, communicate with, or otherwise utilize an electronic report modifier 170. The electronic report modifier 170 can be or include any script, file, program, application, set of instructions, or computer-executable code that can be configured to modify fields in electronic reports 130. The electronic report modifier 170 can parse and evaluate the structure of electronic reports 130. For example, the electronic report modifier 170 can identify the layout, data types, and relationships between different fields of electronic reports 130 by parsing formats such as XML, JSON, or CSV and extracting relevant metadata. The electronic report modifier 170 can process modification requests using natural language processing techniques or direct interaction through a user interface. For example, based on the indication that a candidate action has been interacted with via the chatbot interface 185, the electronic report modifier 170 can execute the corresponding instructions or formatting instructions associated with the candidate action. These formatting instructions can include modifying the underlying report data by adding additional fields with default or calculated values, deleting existing fields, modifying field properties such as data type or format, rearranging the sequence of fields, applying calculations or formulas, filtering data to display specific subsets, or formatting data, such as changing font, color, or alignment, among others. The electronic report modifier 170 can update the electronic report's presentation after modifying the data, for example, by regenerating the electronic report 130 in its original format or updating data within the existing report structure. The electronic report modifier 170 can validate data type compatibility, logical consistency, and adherence to predefined rules or constraints.

The data processing system 105 can include, interface with, communicate with, or otherwise utilize a profile manager 175. The profile manager 175 can be or include any script, file, program, application, set of instructions, or computer-executable code that can be configured to manage profile data structures 125. When electronic reports 130 are generated or updated, the profile manager 175 can access and retrieve the relevant information displayed within the electronic report 130. The profile manager 175 can manage any changes to the profile data structure 125 in response to changes in the data associated with the electronic report 130. The profile manager 175 can assign identifiers to each profile data structure 125 and retrieve or update the profile data based on the identifiers. When new or updated data points are available, the profile manager 175 can identify the corresponding profile data structures 125 using entity identifiers or reference keys and update the profile data structure 125 accordingly based on the changes in the associated data. The profile manager 175 can extract relevant attributes or metadata and query the database 120 using the identifier to access the appropriate profile data structure 125, updating the user profile information associated with the electronic report 130 to indicate any changes. For example, the profile manager 175 can use a device ID, MAC address, or IP address received from the client device 115 to retrieve and update the profile data structure 125 based on changes associated with the electronic report 130.

The data processing system 105 can include, interface with, communicate with, or otherwise utilize an operation controller 180. The operation controller 180 can be or include any script, file, program, application, set of instructions, or computer-executable code that can be configured to manage and execute actions associated with one or more components of the data processing system 105 or the client system 115. The operation controller 180 can define and manage workflows comprised of multiple interconnected tasks. The operation controller 180 can initiate, monitor, and control the execution of workflow steps. The operation controller 180 can implement conditional logic for dynamic workflow routing. The operation controller 180 can execute multiple tasks concurrently through parallel processing. The operation controller 180 can implement error handling and recovery mechanisms for workflow exceptions. The operation controller 180 can track workflow progress and provide status updates. For example, the operation controller 180 can include one or more interfaces to detect input at various portions of a workflow and can provide output responsive to specific portions of a workflow.

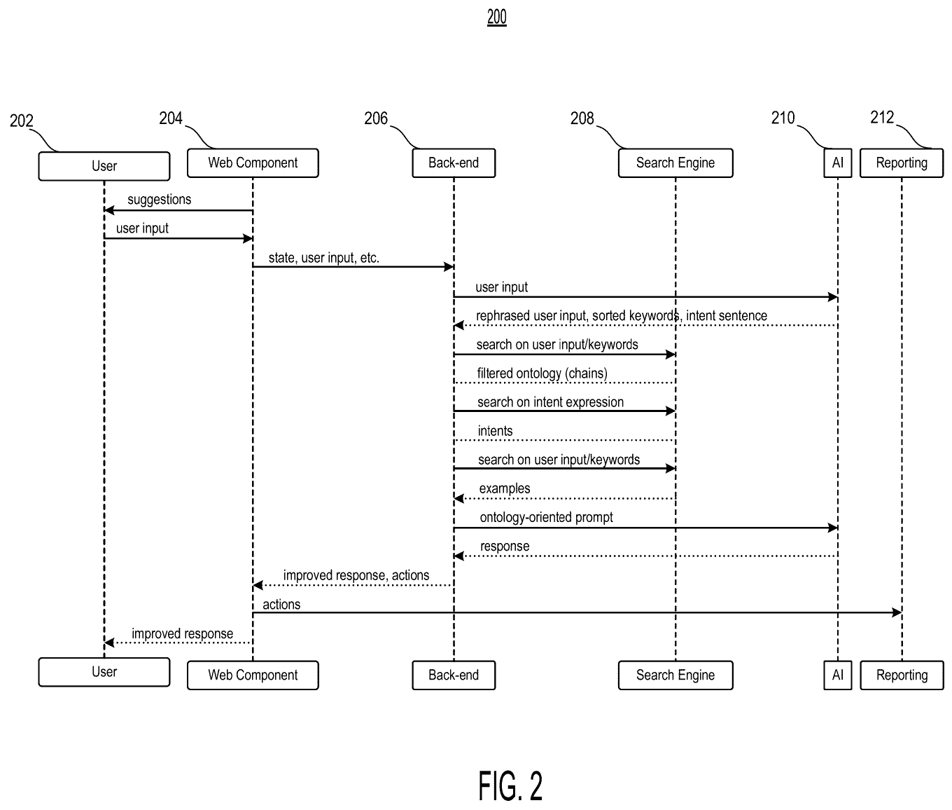

FIG. 2 depicts an example operational system, according to this disclosure. As illustrated by way of example in FIG. 2, an operational system 200 can include at least a web component 204, a back-end component 206, a search engine 208, an artificial intelligence (AI) component 210, and a reporting component 212. The web component 204 can be similar to, and include any of the structure and functionality of, the chatbot interface 185 as described in connection with FIG. 1. The back-end component 206 can be similar to, and include any of the structure and functionality of, the data processing system 105 as described in connection with FIG. 1. The search engine 208 can be similar to, and include any of the structure and functionality of, the search engine 165 as described in connection with FIG. 1. The AI component 210 can include the large language model 160 as described in connection with FIG. 1. The reporting component 212 can be similar to, and include any of the structure and functionality of, the reporting interface 190 as described in connection with FIG. 1.

As shown, the operational system 200 can execute a series of operations to process user input and generate a corresponding electronic report. The web component 204 can present a hardcoded suggestion to the user 202, guiding them on how to initiate the process. The user 202 can input a request in natural language, which the web component 204 can transmit to the back-end component 206. This transmission can include the user ID, the current state of the report (e.g., initially blank), and the textual input. The back-end component 206 can transmit a query or request to the AI component 210 and cause the AI component 210 to generate a list of keywords ranked by relevance, a rephrased version of the user input for enhanced clarity, and an intent sentence that defines the underlying objective of the electronic report.

Based on the list of keywords, a rephrased version of the user input, and the intent sentence, the back-end component 206 can generate a search query for the search engine 208 and cause the search engine 208 to extract relevant ontology elements, intents, and related examples from a database. The back-end component 206 can generate an input context for the AI component 210 based on extracted examples, relevant ontology parts, potential intent, and the expected response format. The AI component 210 can process the input context and generate a response output. The back-end component 206 can validate the response output and resolve any detected errors. The back-end component 206 can transmit the validated response output to the web component 204.

The web component 204 can parse the response output and generate a list of corresponding actions for the user 202. The actions can cause the back-end component 206 to execute the corresponding formatting instructions to modify the electronic report, such as adding or removing fields, changing data types, or rearranging the layout, among others. Upon receiving an interaction with any of these actions, the web component 204 can transmit an indication to the reporting component 212 to display the modified electronic report to the user. This operation can be repeated iteratively until the user is satisfied with the generated electronic report. For example, the operational system 200 can continue to receive user input via the web component 204, process it through the AI component 210, and update the electronic report accordingly until the desired result is achieved.

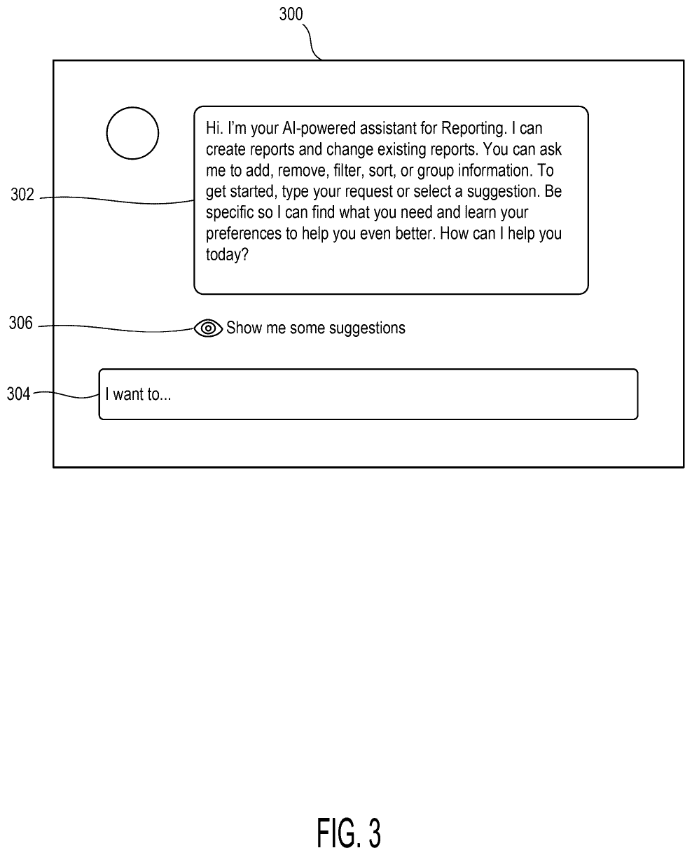

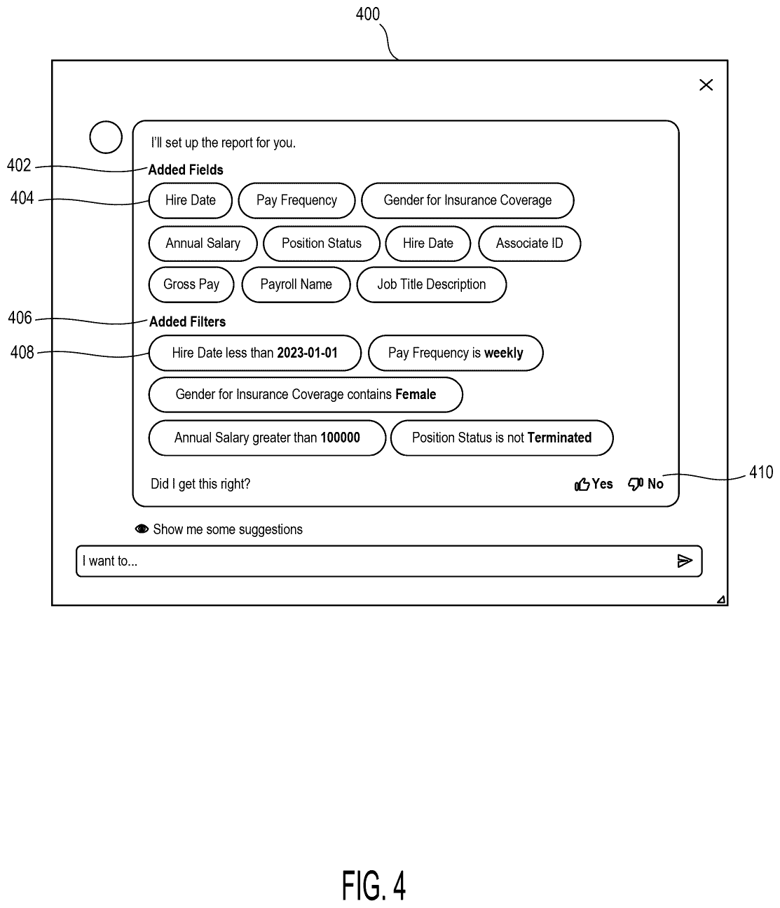

FIGS. 3-4 depict an example chatbot interface. As shown in FIG. 3, the chatbot interface 300 can display a suggestion message 302 to guide the user on how to initiate an interaction. For example, the suggestion message 302 can read, “ . . . You can ask me to add, remove, filter, sort, or group information. To get started, type your request or select a suggestion . . . ”. The chatbot interface 300 can present a request icon 306, such as “show me some suggestions”, to guide the user in initiating an interaction. The request icon 306 can be presented as a button, image, or other visual elements. When the user interacts with the request icon 306 by clicking or tapping on it, the chatbot interface 300 can detect the interaction and cause the data processing system 105 to process the request. Based on the context or intent behind the action, the data processing system 105 can display suggestions via the chatbot interface 300. The suggestions can be generated based on the user's context, previous interactions, or predefined rules within the system.

Upon receiving a user input via a message bar 304, the chatbot interface 300 can be dynamically updated to display fields associated with the electronic report 130. For example, as shown in FIG. 4, the dynamically updated chatbot interface 400 can present fields 402 that can be added to an electronic report 130. Each field 402 can be associated with corresponding candidate actions 404, such as “Hire Date”, “Pay Frequency”, or “Annual Salary”, among others. The modifications can include adding a new field to the electronic report or removing an existing field, among others. The chatbot interface 400 can also display filters 406 to refine and manipulate data within the electronic report 130. Each filter 406 can be associated with corresponding candidate actions 408, such as “Hire Date less than 2023 Jan. 1”, “Annual Salary greater than 100000”, or “Pay Frequency is weekly”, among others. Each candidate action 408 under the added filters 406 can specify a modification to the electronic report 130. The chatbot interface 400 can include thumbs-up and thumbs-down icons 410 to facilitate reinforcement learning. For example, the thumbs-up and thumbs-down icons 410 can allow users to provide feedback on the language model's responses, indicating whether they were relevant to the request or not.

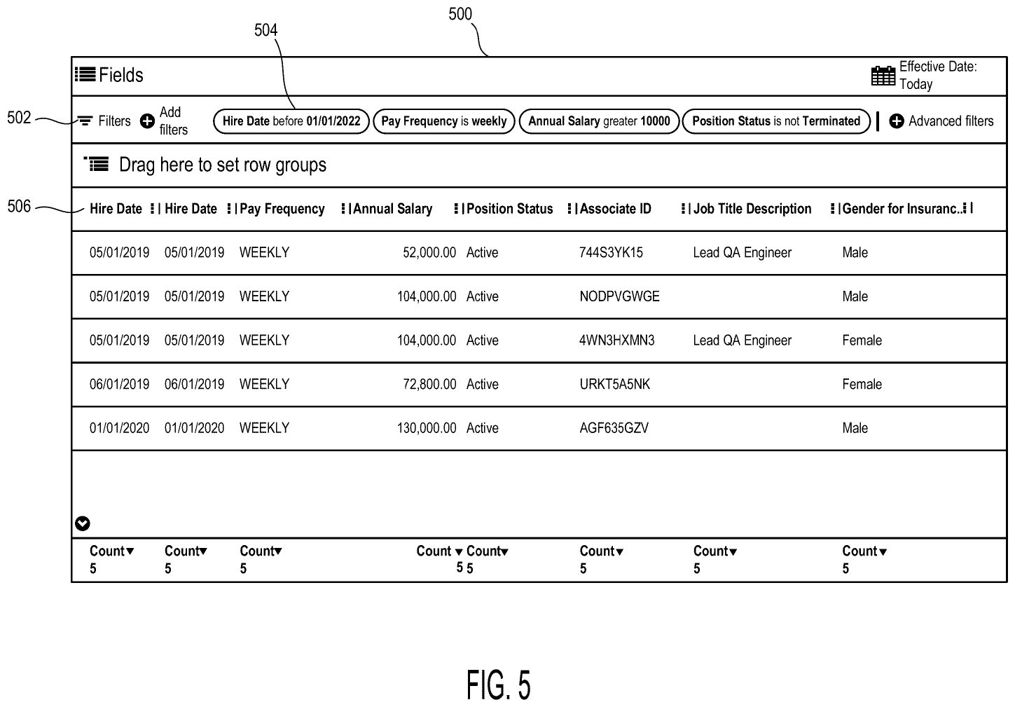

FIG. 5 depicts an example reporting interface 500. The reporting interface 500 can include a filters section 502 that allows users to apply specific conditions to the displayed data. For example, the filters section 502 can present candidate actions 504, such as “Hire Date before Jan. 1, 2022”, which filters data to include only records with a hire date before Jan. 1, 2022, “Pay Frequency is weekly”, which filters data to show only records with a weekly pay frequency, “Annual Salary greater 10000”, which filters data to include records with an annual salary greater than $10,000, and “Position Status is not Terminated”, which filters data to exclude records where the position status is terminated, among others. The reporting interface 500 can display fields 506 that present the data being analyzed. For example, the fields 506 can include “Hire Date”, indicating when the employee was hired, “Pay Frequency”, indicating the frequency at which the employee is paid (e.g., weekly, bi-weekly, monthly), “Annual Salary”, indicating the employee's annual salary, “Position Status”, indicating the current status of the employee's position (e.g., active, terminated), “Associate ID”, indicating an identifier for each employee, “Job Title Description”, indicating the employee's job title, and “Gender for Insurance”, indicating the employee's gender for insurance purposes, among others.

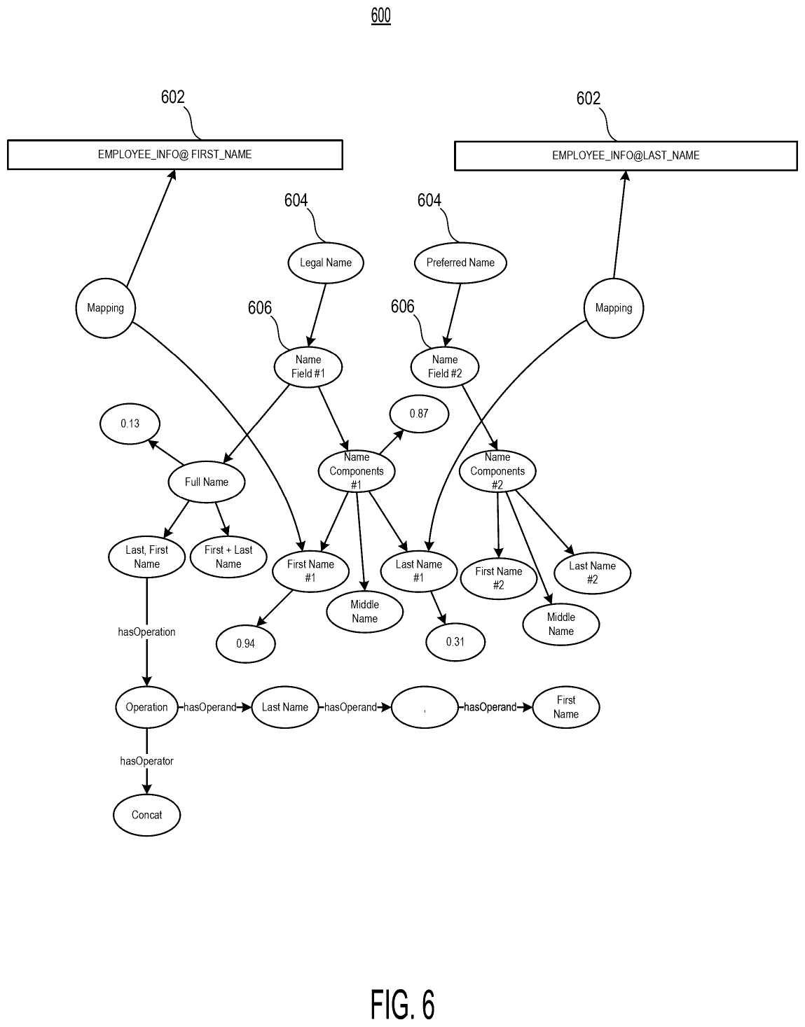

FIG. 6 depicts an example ontology 600. The ontology 600 can be a knowledge graph or semantic network that defines relationships and categories of concepts within a specific domain. The ontology 600 can include nodes 602, relationships 604, and attributes 606. The nodes 602 can indicate entities or concepts within the domain. For example, the nodes 602, such as “First Name” and “Last Name”, can indicate different aspects of employee information. The relationships 604, also known as edges or links, can connect the nodes 602 and define the connections between them. For example, the relationship 604 “Legal Name” or “Preferred Name” can connect the “First Name” node 602 to the “Last Name” node 602 to indicate how a name is composed within a user profile. The attributes 606 can specify the properties or characteristics of nodes 602. In this example, the attributes 606, such as “Name Field #1” and “Name Field #2”, can indicate different configurations for defining an employee's name.

The ontology 600 can associate probability scores with individual nodes or concepts to reflect their relative likelihood or importance within a given dataset. A probability score can correspond to a numerical value that indicates the likelihood of a particular concept or data structure being relevant, frequently encountered, or preferred in a specific context. The probability scores can be based on various factors, such as the frequency of occurrence, which indicates how often a concept appears in the data, the relevance to the domain, which indicates how important the concept is within the specific context, or user preferences, which indicate the patterns or behaviors of users interacting with the ontology, such as commonly selected options or frequently accessed information. The ontology 600 can be used to prioritize and rank the most relevant information based on the associated probability scores. The higher the probability score, the more likely the system may prioritize that concept in tasks such as search queries, report generation, or data analysis.

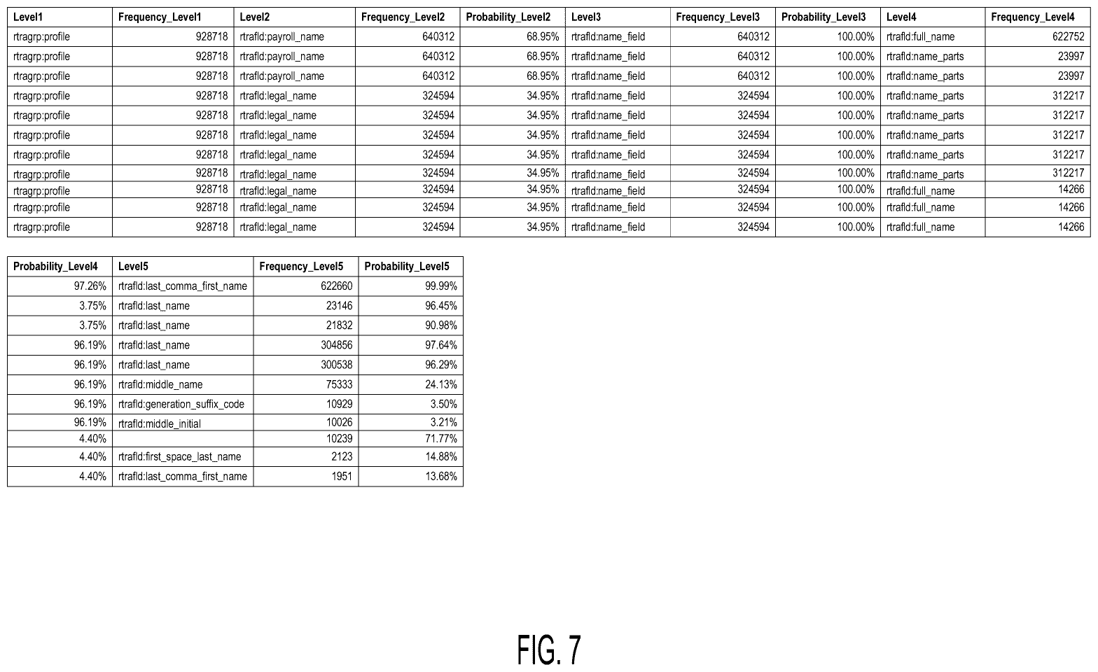

As shown in FIG. 7, the concept of an employee's payroll name is associated with a probability score of 99.99% for the format “last_comma_first_name” based on the observed frequency of this naming pattern in the data. Other possible formats, such as using the first name or last name, can have lower probability scores if they are less frequently encountered in the data. In another example, if the “first_space_last_name” format is used in only 14.88% of the records for fields such as payroll name or legal name, the format can have a corresponding probability score of 14.88% for that specific field. Additionally, user preferences can further influence these probability scores. For example, if users consistently select the “last_comma_first_name” format when interacting with the payroll name field, this behavior can reinforce the relevance of that format. Conversely, formats that are less frequently selected or interacted with, such as “first_space_last_name”, may have a lower probability score, for instance, in the context of managing payroll or legal name fields, depending on the implementation.

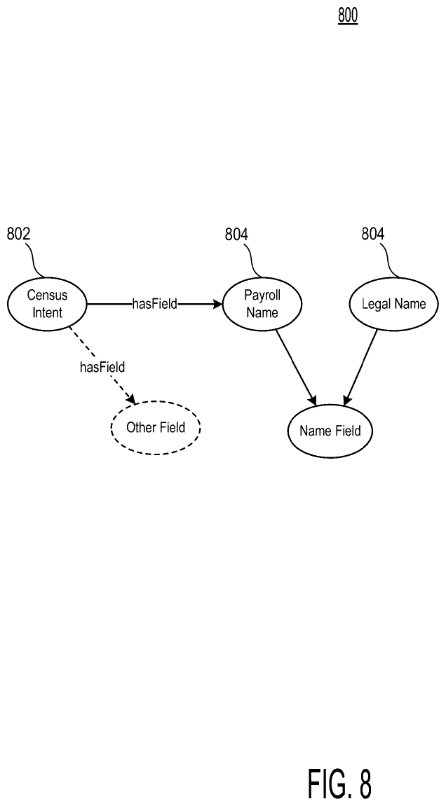

FIG. 8 depicts an example ontology 800 of core concepts related to report intents. The report intents can specify the overall goals or objectives that users may have when interacting with a reporting system. A report intent can specify how users can combine core concepts to achieve their goals. For example, the “Census Intent” 802 can indicate an intent related to collecting census information. The census intent 802 can be associated with one or more fields or nodes 804, such as “Payroll Name” and “Legal Name”. In this instance, the nodes 804 can indicate that the census intent 802 includes collecting information related to payroll names or legal names.

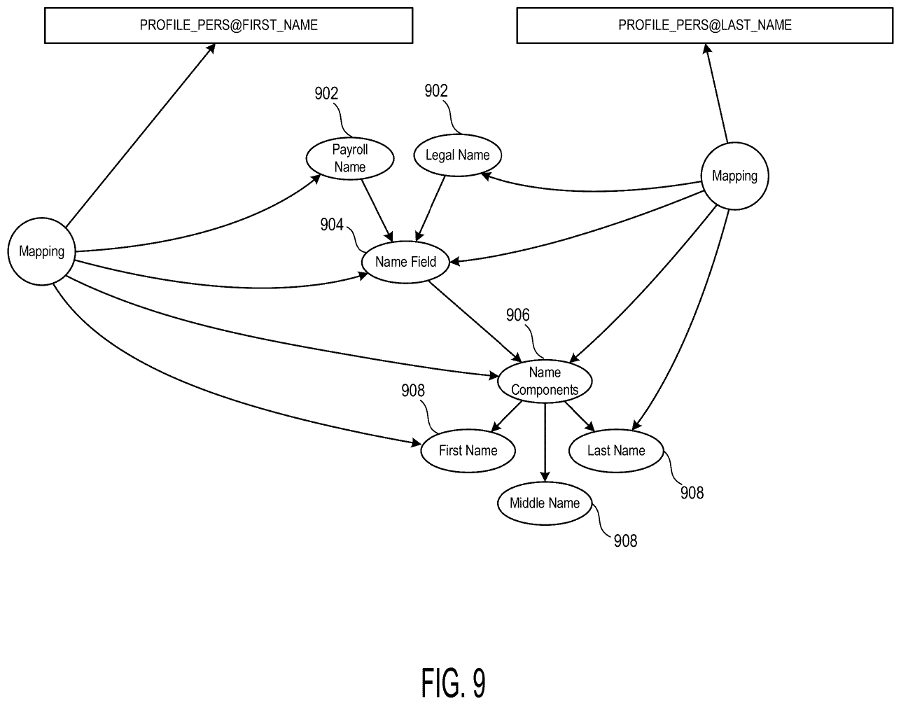

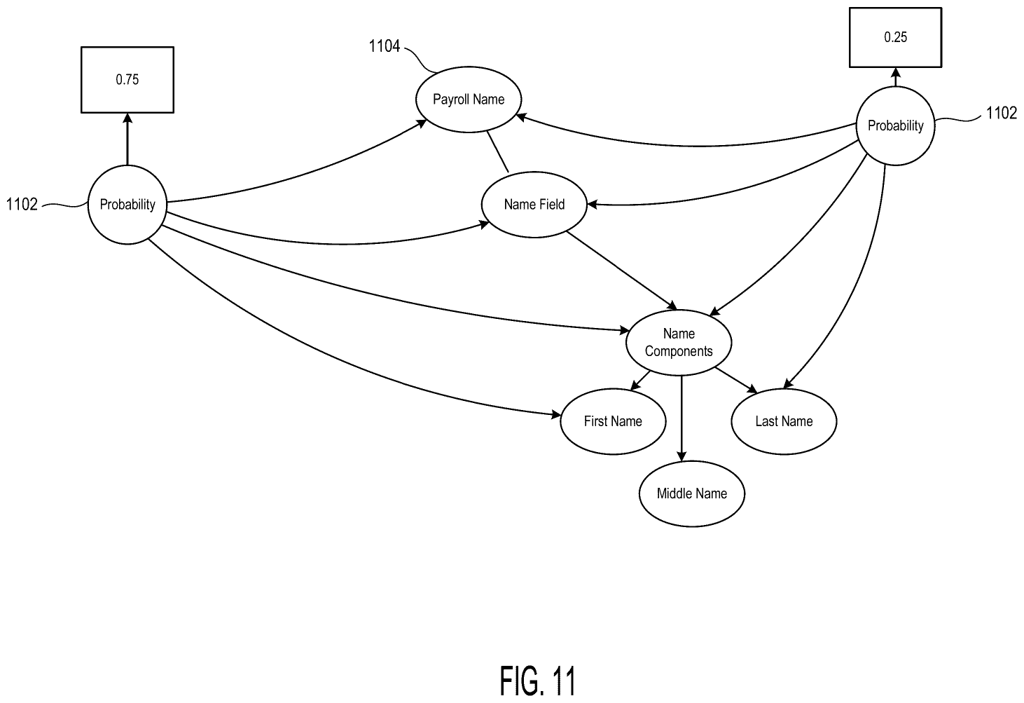

FIGS. 9-11 depict an example ontology mapping that can specify how data can be structured and organized within a system. The ontology mapping can define the relationships between various nodes, which can specify concepts or data points. For example, as shown in FIG. 9, the “Payroll Name” node 902 can be mapped to the “Name Field” node 904, indicating that payroll name information can be stored under the broader category of name fields. Similarly, the “Legal Name” node 902 can also be mapped to the “Name Field” node 904, indicating that legal name data can share a structural similarity with payroll name data. The “Payroll Name” and “Legal Name” nodes 902 can be connected to the “Name Field” node 904, which can be associated with a more granular concept, the “Name Components” node 906. As shown, the “Name Components” node 906 can parse the broader “Name Field” node 904 into individual attributes 908, such as “First Name”, “Middle Name”, and “Last Name,” indicating the specific components that make up a full name.

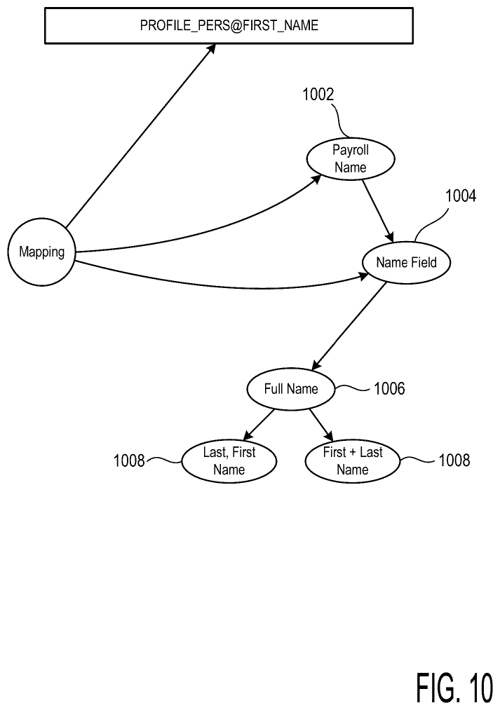

Each concept in the ontology can be associated with a specific attribute that further defines its characteristics and role within the data structure. For example, as shown in FIG. 10, the “Payroll Name” can be mapped to “Name Field” node 1002, indicating that the payroll name data can be categorized as a specific type of name field. For example, the “Name Field” node 1004 is associated with a “Full Name” node 1006, which can specify a comprehensive view of an individual's full name. The “Full Name” node 1006 can be defined as a combination of multiple attributes 1008, such as “Last, First Name” (e.g., Doe, John) and “First+Last Name” (e.g., John Doc). The attributes 1008 can be used to specify different configurations or formats of a full name that the system can identify, process, and store.

The ontology can assign probability values to individual concepts to indicate their relative importance or likelihood of occurrence. The probabilities can be based on historical data and usage patterns. The probabilities can be categorized as generic, product-specific, or client-specific. A generic probability node can specify general likelihoods across multiple products or clients, while a product-specific probability node can be directed to a particular product, and a client-specific probability node can be specific to a client. For example, the probability nodes 1102 associated with a “Payroll Name” concept or node 1004 can indicate the likelihood of different name formats associated with the payroll name. For example, a “First Name+Last Name” format can have a lower probability score compared to “Last Name comma First Name” if historical data shows that the latter format is more common in the given context.

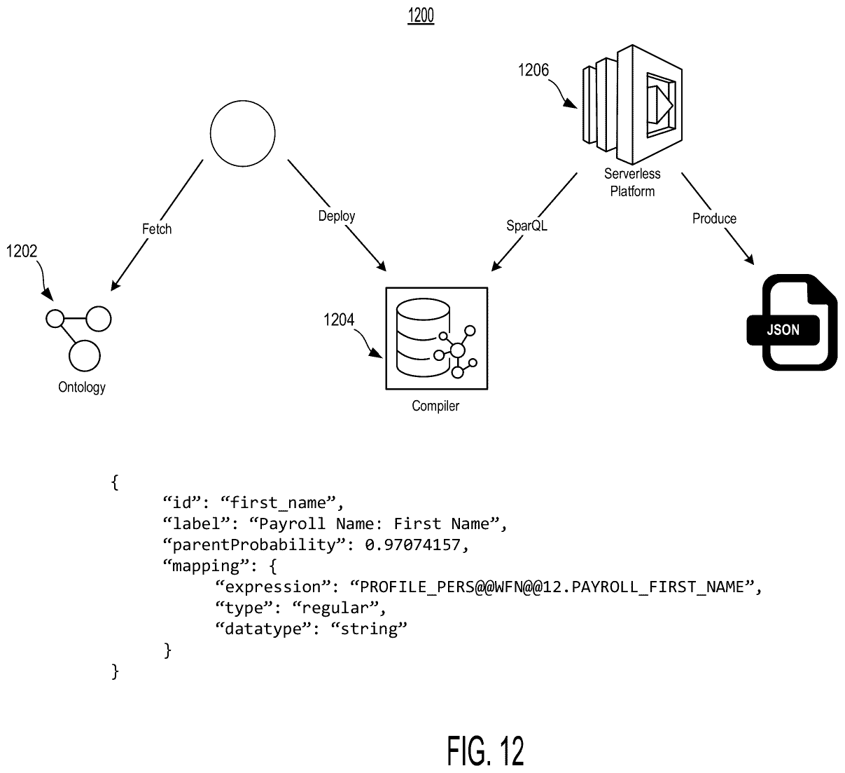

FIG. 12 depicts an operational system that integrates an ontology with a serverless platform to process and deliver data. The system 1200 can fetch relevant data from the ontology 1202, which can be a knowledge base that defines relationships and categories of concepts within a specific domain. The fetched data can be deployed to a compiler 1204, which translates the fetched ontology 1202 into a format suitable for execution on the serverless platform 1206, a cloud-based infrastructure that automatically manages resources. Once deployed, SparQL queries can be used to interact with and retrieve RDF data from the serverless platform 1206. The system 1200 can generate the processed results in JSON format. In an example implementation, the system 1200 can fetch the “first_name” node from the ontology 1202. The ontology 1202 can assign a probability score of 0.97074157 to the “first_name” node, indicating its relevance or frequency within the data. The system can implement mapping, such as mapping the expression, “PROFILE_PERS@PAYROLL_FIRST_NAME”, to identify how the “first_name” data is associated with payroll name and structured within the ontology 1202. For example, the mapping can specify the relationship between the first name and the payroll name. The system 1200 can process the fetched data using the serverless platform 1206 and generate the results in a desired format, such as JSON.

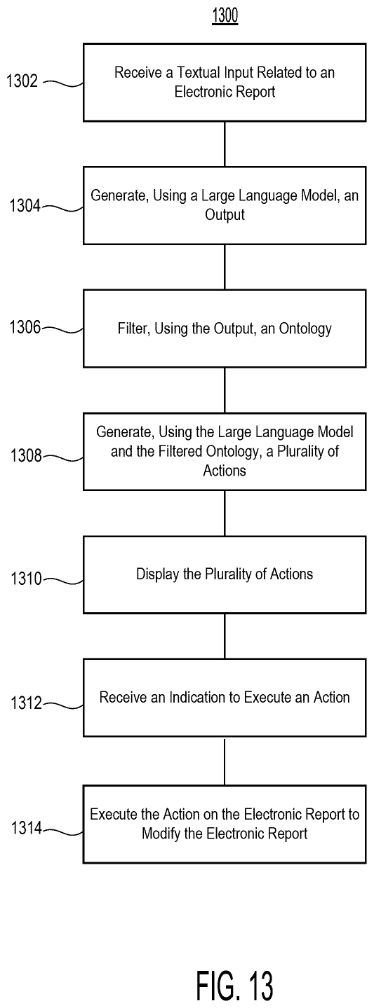

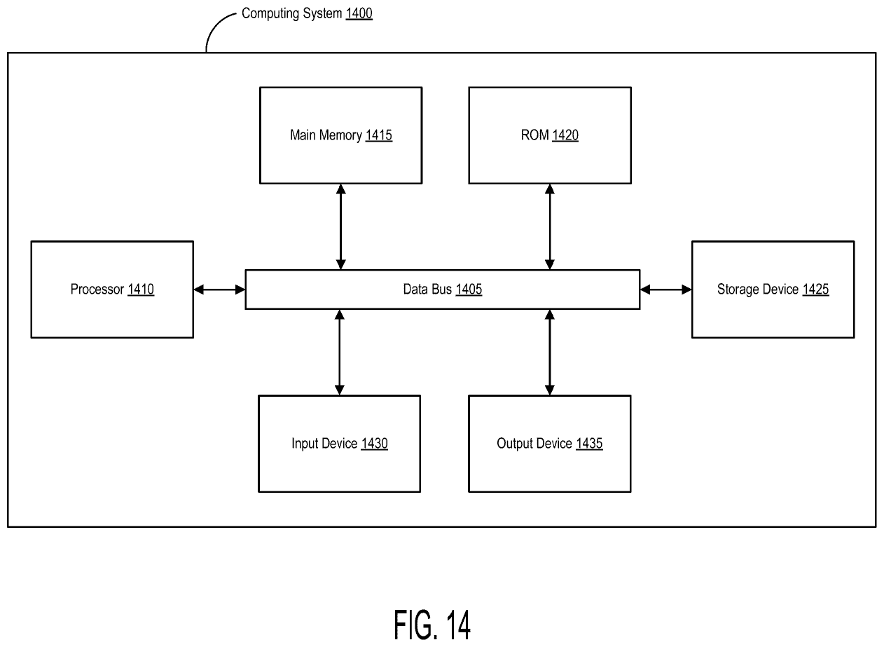

FIG. 13 depicts a method 1300 of data structure modification using a virtual assistant based on large language models and ontology. The method 1300 can be implemented using a system 100, 200, 1200, 1400, or any other features discussed in FIGS. 1-2, FIG. 12, or FIG. 14. The method can include Acts 1302-1314. The Acts 1302-1314 can be executed in any order or sequence.

At 1302, the method 1300 can receive a textual input related to an electronic report. In an aspect, the method can include receiving, via a chatbot interface, the textual input related to the electronic report. The chatbot interface can be decoupled from a reporting interface displaying the electronic report.

At 1304, the method 1300 can generate, using a large language model, an output. In an aspect, the method can include generating, in response to the textual input, using the large language model, the output, including a set of keywords, a rephrased version of the textual input, and an intent sentence. In another aspect, the method can include, in response to receiving the textual input, determining a user identifier and a state of the electronic report. The state of the electronic report can correspond to an initial state of the electronic report prior to any modifications being made to the electronic report. In another aspect, the method can include providing the textual input, the user identifier, and the state of the electronic report to the large language model to cause the large language model to generate the output.

At 1306, the method 1300 can filter, using the output, an ontology. The ontology can include a resource description framework including a plurality of nodes. Each node can include a plurality of attributes. Each node can be associated with a probability score based on a relative frequency of one or more attribute combinations in historical data maintained in the database. In an aspect, the method can include filtering, using the output from the large language model, the ontology stored in a database to generate a filtered ontology, including one or more ontology elements, intents, and examples. In another aspect, the method can include generating a search query based on the set of keywords, the rephrased version of the textual input, and the intent sentence. In another aspect, the method can include providing the search query to a search engine to identify the one or more ontology elements, the intents, and the examples.

At 1308, the method 1300 can generate, using the large language model and the filtered ontology, a plurality of actions. In an aspect, the method can include generating, using the large language model and the filtered ontology, the actions that are compatible with the electronic report. In another aspect, the method can include generating an input context based on the filtered ontology. In another aspect, the method can include providing the input context to the large language model to cause the large language model to generate the actions. Each action can correspond to a respective field of the electronic report.

At 1310, the method 1300 can display the plurality of actions. In an aspect, the method can include displaying, via the chatbot interface, the plurality of actions.

At 1312, the method 1300 can receive an indication to execute an action. In an aspect, the method can include receiving, via the chatbot interface, an indication to execute the action of the plurality of actions.

At 1314, the method 1300 can execute the action on the electronic report to modify the electronic report. In an aspect, the method can include providing, responsive to the indication, instructions to execute the action on the electronic report to modify the electronic report.

FIG. 14 depicts a block diagram of a computing system 1400 for implementing the embodiments of the technical solutions discussed herein, in accordance with various aspects. FIG. 14 illustrates a block diagram of an example computing system 1400, which can also be referred to as the computer system 1400. Computing system 1400 can be used to implement elements of the systems and methods described and illustrated herein. Computing system 1400 can be included in and run any device (e.g., a server, a computer, a cloud computing environment or a data processing system).

Computing system 1400 can include at least one bus data bus 1405 or other communication device, structure or component for communicating information or data. Computing system 1400 can include at least one processor 1410 or processing circuit coupled to the data bus 1405 for executing instructions or processing data or information. Computing system 1400 can include one or more processors 1410 or processing circuits coupled to the data bus 1405 for exchanging or processing data or information along with other computing systems 1400. Computing system 1400 can include one or more main memories 1415, such as a random access memory (RAM), dynamic RAM (DRAM), cache memory or other dynamic storage device, which can be coupled to the data bus 1405 for storing information, data and instructions to be executed by the processor(s) 1410. Main memory 1415 can be used for storing information (e.g., data, computer code, commands or instructions) during execution of instructions by the processor(s) 1410.

Computing system 1400 can include one or more read only memories (ROMs) 1420 or other static storage device 1425 coupled to the bus 1405 for storing static information and instructions for the processor(s) 1410. Storage devices 1425 can include any storage device, such as a solid-state device, magnetic disk or optical disk, which can be coupled to the data bus 1405 to persistently store information and instructions.

Computing system 1400 can be coupled via the data bus 1405 to one or more output devices 1435, such as speakers or displays (e.g., liquid crystal display or active matrix display) for displaying or providing information to a user. Input devices 1430, such as keyboards, touch screens or voice interfaces, can be coupled to the data bus 1405 for communicating information and commands to the processor(s) 1410. Input device 1430 can include, for example, a touch screen display (e.g., output device 1435). Input device 1430 can include a cursor control, such as a mouse, a trackball, or cursor direction keys, for communicating direction information and command selections to the processor(s) 1410 for controlling cursor movement on a display.

The processes, systems and methods described herein can be implemented by the computing system 1400 in response to the processor 1410 executing an arrangement of instructions contained in main memory 1415. Such instructions can be read into main memory 1415 from another computer-readable medium, such as the storage device 1425. Execution of the arrangement of instructions contained in main memory 1415 causes the computing system 1400 to perform the illustrative processes described herein. One or more processors 1410 in a multi-processing arrangement can also be employed to execute the instructions contained in main memory 1415. Hard-wired circuitry can be used in place of or in combination with software instructions together with the systems and methods described herein. Systems and methods described herein are not limited to any specific combination of hardware circuitry and software.

Although an example computing system has been described in FIG. 14, the subject matter, including the operations described in this specification, can be implemented in other types of digital electronic circuitry, or in computer software, firmware, or hardware, including the structures disclosed in this specification and their structural equivalents, or in combinations of one or more of them.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes can be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively, or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device,” “component” or “data processing apparatus” or the like encompass various apparatuses, devices, and machines for processing data, including, by way of example, a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including, by way of example, semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While operations are depicted in the drawings in a particular order, such operations are not required to be performed in the particular order shown or in sequential order, and all illustrated operations are not required to be performed. Actions described herein can be performed in a different order.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

References to “or” can be construed as inclusive so that any terms described using “or” can indicate any of a single, more than one, and all of the described terms. References to at least one of a conjunctive list of terms can be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as substitutions, changes and omissions can be made in the design, operating conditions and arrangement of the disclosed elements and operations without departing from the scope of the present disclosure.

What is claimed is:

1. A system, comprising:
one or more processors, coupled with memory, to:
receive, via a chatbot interface, a textual input related to an electronic report;
generate, in response to the textual input, using a large language model, an output comprising a set of keywords, a rephrased version of the textual input, and an intent sentence;
filter, using the output from the large language model, an ontology stored in a database to generate a filtered ontology comprising one or more ontology elements, intents, and examples;
generate, using the large language model and the filtered ontology, a list of actions that are executable to modify the electronic report;
display, via the chatbot interface, the list of actions;
receive, via the chatbot interface, an indication to execute an action from the list of actions; and
provide, responsive to the indication, instructions to execute the action associated with the electronic report to modify the electronic report.

2. The system of claim 1, wherein the chatbot interface is decoupled from a reporting interface displaying the electronic report.

3. The system of claim 1, wherein in response to receiving the textual input, the one or more processors are further configured to determine a user identifier and a state of the electronic report.

4. The system of claim 3, wherein the state of the electronic report corresponds to an initial state of the electronic report prior to any modifications being made to the electronic report.

5. The system of claim 3, wherein the one or more processors are further configured to provide the textual input, the user identifier, and the state of the electronic report to the large language model to cause the large language model to generate the output.

6. The system of claim 1, wherein the one or more processors are further configured to:
generate a search query based on the set of keywords, the rephrased version of the textual input, and the intent sentence; and
provide the search query to a search engine to identify the one or more ontology elements, the intents, and the examples.

7. The system of claim 1, wherein the one or more processors are further configured to:
generate an input context based on the filtered ontology; and
provide the input context to the large language model to cause the large language model to generate the list of actions.

8. The system of claim 1, wherein the ontology comprises a resource description framework including a plurality of nodes, wherein each node of the plurality of nodes comprises a plurality of attributes.

9. The system of claim 8, wherein the node is associated with a probability score based on a relative frequency of one or more attribute combinations in historical data maintained in the database.

10. The system of claim 1, wherein each action from the list of actions corresponds to a respective field of the electronic report.

11. A method, comprising:
receiving, via a chatbot interface, a textual input related to an electronic report;
generating, in response to the textual input, using a large language model, an output comprising a set of keywords, a rephrased version of the textual input, and an intent sentence;
filtering, using the output from the large language model, an ontology stored in a database to generate a filtered ontology comprising one or more ontology elements, intents, and examples;
generating, using the large language model and the filtered ontology, a list of actions that are executable to modify the electronic report;
displaying, via the chatbot interface, the list of actions;
receiving, via the chatbot interface, an indication to execute an action from the list of actions; and
providing, responsive to the indication, instructions to execute the action associated with the electronic report to modify the electronic report.

12. The method of claim 11, wherein the chatbot interface is decoupled from a reporting interface displaying the electronic report.

13. The method of claim 11, wherein in response to receiving the textual input, further comprising determining a user identifier and a state of the electronic report.

14. The method of claim 13, wherein the state of the electronic report corresponds to an initial state of the electronic report prior to any modifications being made to the electronic report.

15. The method of claim 13, further comprising providing the textual input, the user identifier, and the state of the electronic report to the large language model to cause the large language model to generate the output.

16. The method of claim 11, further comprising:
generating a search query based on the set of keywords, the rephrased version of the textual input, and the intent sentence; and
providing the search query to a search engine to identify the one or more ontology elements, the intents, and the examples.

17. The method of claim 11, further comprising:
generating an input context based on the filtered ontology; and
providing the input context to the large language model to cause the large language model to generate the list of actions.

18. The method of claim 11, wherein the ontology comprises a resource description framework including a plurality of nodes, wherein each node of the plurality of nodes comprises a plurality of attributes.

19. The method of claim 18, wherein the node is associated with a probability score based on a relative frequency of one or more attribute combinations in historical data maintained in the database.

20. A non-transitory computer readable medium including one or more instructions stored thereon and executable by a processor to:
receive, by the processor, via a chatbot interface, a textual input related to an electronic report;
generate, by the processor, in response to the textual input, using a large language model, an output comprising a set of keywords, a rephrased version of the textual input, and an intent sentence;
filter, by the processor, using the output from the large language model, an ontology stored in a database to generate a filtered ontology comprising one or more ontology elements, intents, and examples;
generate, by the processor, using the large language model and the filtered ontology, a list of actions that are executable to modify the electronic report;
display, by the processor, via the chatbot interface, the list of actions;
receive, by the processor, via the chatbot interface, an indication to execute an action from the list of actions; and
provide, by the processor, responsive to the indication, instructions to execute the action associated with the electronic report to modify the electronic report.
